(19) United States
(12) Patent Application Publication
(10) Pub. No.: US 2009/0217953 A1
(43) Pub. Date: Sep. 3, 2009

(54) DRIVE ROLLER FOR A CLEANING SYSTEM

(76) Inventors: HUI CHEN, Burlingame, CA (US); Martin S. Kurnadi, Cupertino, CA (US); Chidambara A. Ramalingam, Fremont, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/038,968

(22) Filed: Feb. 28, 2008

(51) Int. Cl. B65G 13/02; B08B 3/00; B08B 13/00

(52) U.S. Cl. 134/86; 198/780

(57) ABSTRACT

A drive roller for use in a semiconductor substrate cleaning system is provided. In one embodiment, a drive roller includes an outer ring having a disk-shaped body, wherein the disk-shaped body has an inner cylindrical, an upper wall, and an outer cylindrical wall defining a cavity within the disk-shaped body. An inner ring is disposed within the cavity. A groove is formed along an outer side of the inner ring. The groove faces an inner surface of the outer cylindrical wall of the outer ring.

### BACKGROUND OF THE DISCLOSURE

1. Field of the Invention

The present invention relates to an apparatus of a drive roller for a cleaning system, more specifically, a drive roller used in a semiconductor substrate cleaning for use in semiconductor manufacturing.

2. Description of the Background Art

In the fabrication of integrated circuits and other electronic devices, multiple layers of conducting, semiconducting, and dielectric materials are deposited on or removed from a surface of a substrate. As layers of materials are sequentially deposited and removed, the substrate may become non-planar and require planarization, in which previously deposited material is removed from the substrate to form a generally even, planar or level surface. The process is useful in removing undesired surface topography and surface defects, such as rough surfaces, agglomerated materials, crystal lattice damage and scratches. The planarization process is also useful in forming features on the substrate by removing excess deposited material used to fill the features and to provide an even or level surface for subsequent deposition and/or other integrated circuit fabrication process.

During planarization process, a polishing fluid, such as slurry, may polish away material from the substrate surface. Some contaminants or particles may be generated during the polishing process. The slurry contaminants and/or particles may be present on the substrate after polishing. Accordingly, a cleaning process is performed after the polishing process to remove the polishing residuals, particles, and contaminants from the substrate surface. In one type of conventional cleaning process, the substrate is rotated during cleaning to provide uniform cleaning across the entire wafer surface. In conventional practice, the substrate is typically positioned on a plurality of rollers in a rotation system. The rollers hold and rotate the substrate during cleaning.

During cleaning, the substrate may slip while in contact with the rollers, thereby causing substrate rotation to momentarily decelerate or cease. The change in rotation may not only causes uneven cleaning or processing across the substrate surface, but also generate particles which may potentially damage and contaminate the substrate. Furthermore, once the substrate has slipped from the roller, the substrate may become misaligned in the cleaner and be damaged when retrieved by a robot. Additionally, after a number of cleaning cycles, the material used to fabricate the roller may be eroded, deteriorated, or worn out by the chemicals utilized during cleaning the substrate. Erosion or gradual degradation of the roller material may create particles and reduce the frictional force between the roller and the substrate, thereby increasing the potential of substrate slippage and contamination during cleaning.

Therefore, there is a need for an improved roller.

### SUMMARY OF THE INVENTION

The present invention provides an improved design and configuration of a drive roller for use in a semiconductor substrate cleaning system. In one embodiment, a drive roller includes an outer ring having a disk-shaped body, wherein the disk-shaped body has an inner cylindrical, an upper wall, and an outer cylindrical wall defining a cavity within the disk-shaped body. An inner ring is disposed within the cavity. A groove is formed along an outer side of the inner ring, wherein the groove faces an inner surface of the outer cylindrical wall of the outer ring.

In another embodiment, a drive roller disposed in a semiconductor substrate cleaning system is fabricated by a material selected from a group consisting of polytetrafluoroethylene (PTFE), polytetrafluoroethylene (PTFE) containing material and fluoroelastomer and polytetrafluoroethylene (PTFE) containing material. The drive roller is configured to rotate a substrate disposed in the cleaning system.

In yet another embodiment, a semiconductor substrate cleaning system includes a base adapted to receive a substrate, at least a drive roller fabricated from a first material arranged to rotate the substrate disposed on the base, at least one idler fabricated from a second material configured to engage the substrate toward the drive roller, wherein the second material has a hardness greater than the first material.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIG. 1 depicts a schematic view of one embodiment of a cleaning system in accordance with the invention;

FIG. 2A-2B depict a cross sectional view of the roller of FIG. 1;

FIG. 3A-3C depict a top isometric, top and bottom view of a roller that may be used in the cleaning system of FIG. 1; and

FIG. 4 depicts a schematic view of another embodiment of a cleaning system in accordance with the invention.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention provides a drive roller having an improved contact surface and rotation control. The drive roller is particularly suitable for use in a semiconductor substrate cleaning system. In one embodiment, the drive roller is fabricated from a material having high hardness, wear resistance, and chemical and temperature compatibility, thereby providing sufficient friction to enjoy good rotation control while engaged with a substrate during cleaning processes. The improved material and roller configuration increases the drive roller serve life, thereby advantageously reducing the overall cost of ownership of the semiconductor cleaning system.

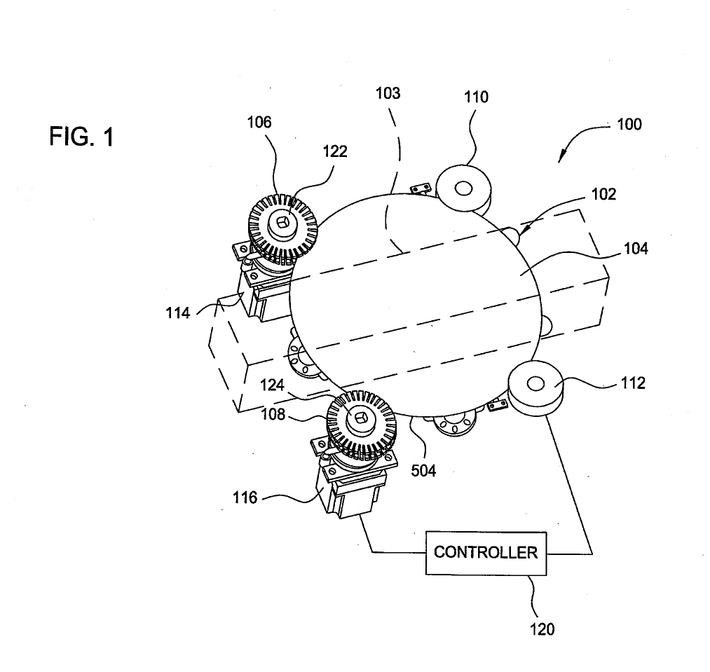

FIG. 1 depicts a schematic view of one embodiment of a cleaning system 100 that may be used to clean a substrate. In one embodiment, the cleaning system 100 may be used to clean substrates after a planarization process, a deposition process, or other process as needed. For example, the substrate may be cleaned after a chemical mechanical planarization process (CMP), an electrochemical mechanical planarization process (ECMP), a electroplating or electroless plating process, and so on.

In one embodiment, the cleaning system 100 includes a base 102, one or more drive rollers and one or more idlers. At least one cleaning element 103, shown in phantom, such as one or more brushes, fluid jets, sonic generators and the like, are positioned in the cleaning system 100 to engage and clean the substrate in a suitable manner. In the embodiment of FIG. 1, two drive rollers 106, 108 and two idlers 110, 112 are utilized. The base 102 is utilized to receive a substrate 104 thereon. Referring temporality to FIG. 5, the substrate 104 may include two major surfaces 502, 502′ and a substrate edge 504. The edge 504 of the substrate 104 may include an outer edge 510 and bevels 512, 514. The bevels 512, 514 meet at the outer edge 510 located in the edge region 504 of the substrate 104. Referring back to FIG. 1, the cleaning system 100 may be utilized to clean the substrate edge region 504, the outer edge 510, two major surfaces 502. 502′ and the bevels 512, 514.

The drive rollers 106, 108 and the idlers 110, 112 are adapted to rotate the substrate 104 during cleaning. In one embodiment, the drive rollers 106, 108 may be actuated by drivers 114, 116, such as motors, gears, belts or the like, to rotate the substrate 104 positioned on the base 102. The idlers 110, 112 contact the substrate 104 and roll passively therewith so as to secure the rotation of the substrate 104 about a center axis. As the drive rollers 106, 108 are actuated to rotate, the drive rollers 106, 108 spin the substrate 104 in the direction imparted by the drive rollers 106, 108. The idlers 110, 112 contact the substrate 104 from the opposing side of the substrate 104 relative to the drive rollers 106, 108 as to maintain the substrate in contact with the drive rollers 106, 108 while spinning.

In one embodiment, a sensor (not shown) may be interfaced with the idlers 110, 112. The sensor may provide a signal indicative of idler and/or substrate rotation rate to a controller 120 of the cleaning system 100. Based on the information provided by the sensor, the controller 120 may set the substrate rotation rate by using closed loop control to adjust the power supplied to drivers 114, 116 that control the rotation rate of the driver rollers 106, 108. Since the idlers are free to spin with the substrate, and mismatch between the idler and drive roller rotation will be indicative of slippage between at least one of the drive rollers or idler. The controller 120 may be, for example, a microprocessor or microcontroller, programmable logic controller, or any suitable software, and/or hardware control device.

In one embodiment, the drive roller 106, 108 is mounted on appropriate shafts 122, 124 from the drivers 114, 116. The shafts drivers 114, 116 may be selectively repositioned laterally to allow position adjustment of the drive rollers 106, 108 and then secured by clamp or fastener to retain the desired drive roller position.

Although the embodiment depicted in FIG. 1 illustrates the cleaning system 100 holding the substrate 104 oriented in a horizontal plane, it is contemplated that the substrate 104 may be held and rotated in other planes, including a vertical plane, and/or be moved between different planes by the system 100 while rotating.

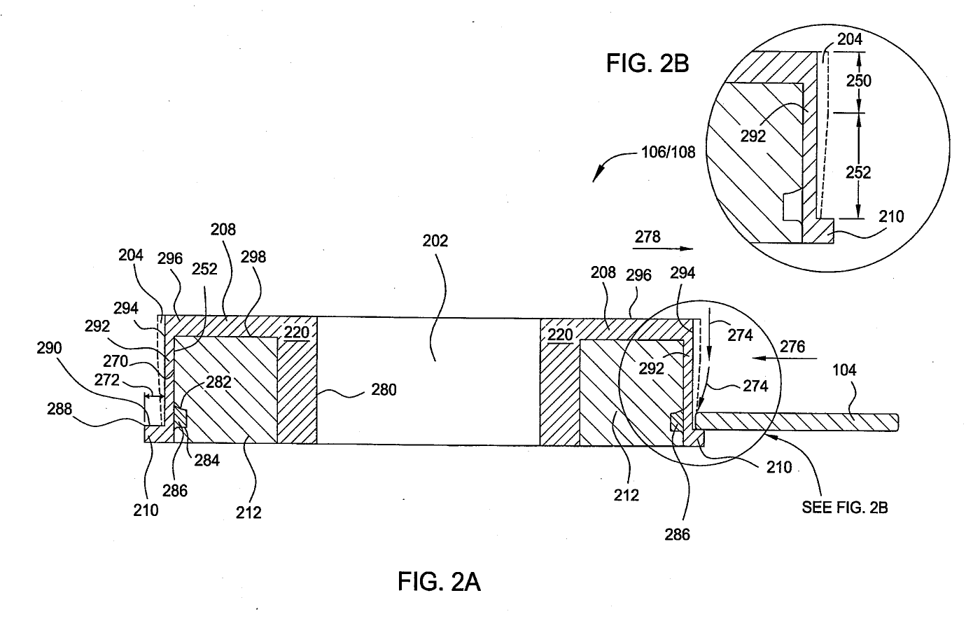

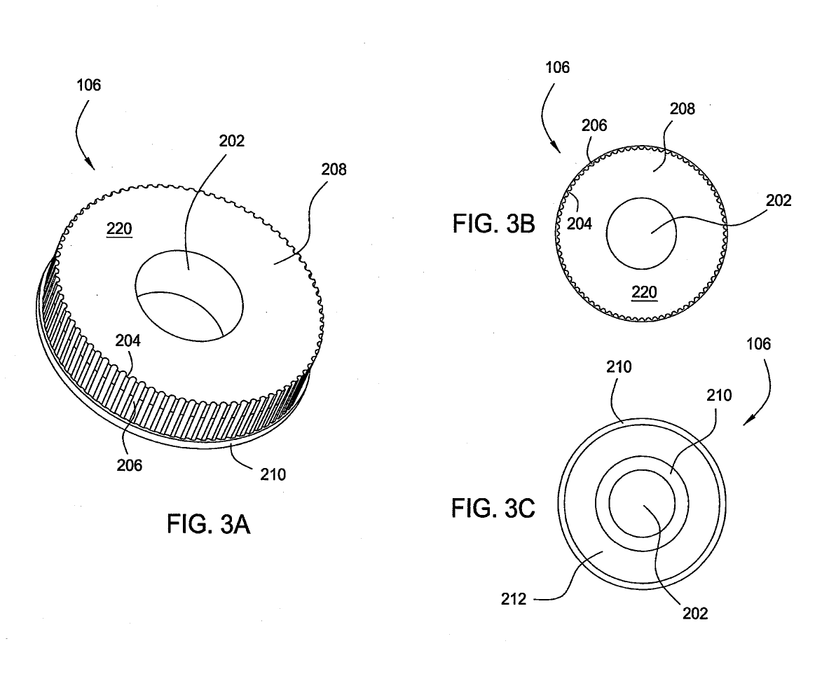

FIG. 2A depicts a cross sectional view of one embodiment of the drive roller 106 of FIG. 1. FIGS. 3A-C which depict isometric, top and bottom views of the roller 106 may be referred to simultaneously for clarity of description. The drive roller 108 may be similarly configured. The drive roller 106 has an inner ring 212 at least partially surrounded by an outer ring 208. The outer ring 208 has a disk-shaped body 220 having an inner cylindrical wall 280, an upper wall 296, and an outer cylindrical wall 292. The inner cylindrical wall 280 defines a center opening 202 formed through the center of the disk-shaped body 220.

The upper wall 296 of the outer ring 208 connects the inner cylindrical wall 208 to the outer cylindrical wall 292, defining a cavity 298 within the disk-shaped body 220. In one embodiment, the dimension of the cavity 298 is sized to accommodate the inner ring 212, thereby allowing the inner ring 212 to be inserted within the cavity 298 of the outer ring 208.

The outer ring 208 includes a lip 210 extending outwardly from an outer surface 294 of a distal end the outer cylindrical wall 292, defining a step 290 along the outer surface 294. A plurality of the sloped flanges 204 are attached on the outer surface 294 of the outer cylindrical wall 292 above the lip 210. As shown in the enlarged illustration of the sloped flange 204 in FIG. 2B, the sloped flange 204 has an upper flat portion 250 and a tapered portion 252. The tapered portion 252 extends from the upper flat surface 250 and slopes radially inward to contact the lip 210. The sloped flange 204 has a width which is smaller than a width 272 of the lip 210, thereby causing the substrate 104 to be urged securely against the step 290 defined by the flange 204 and the lip 250. In one embodiment, the lip 210 may have the radial width 272 between about 0 millimeter (mm) and about 3 millimeter (mm), such as about 1.5 millimeter (mm).

In one embodiment, the outer ring 208 may be fabricated from a material with sufficient elasticity, flexibility and frictional force to grip the substrate 104 while having minimal wear or particle generation. Additionally, the material comprising the outer ring 208 may have certain degree of chemical and temperature resistance selected to prevent the outer ring 208 from damage or degradation after a number of processing cycles in the environment of the cleaner system 100. In one embodiment, the outer ring 208 may be fabricated by a plastic material. In another embodiment, the outer ring 208 may be fabricated by a material selected from a group consisting of polytetrafluoroethylene (PTFE), polytetrafluoroethylene (PTFE) containing material, and fluoroelastomer and polytetrafluoroethylene (PTFE) containing material. The material of the outer ring 208 is configured to have hardness between about 50 Shore A and about 80 Shore A, such as between about 60 Shore A and about 65 Shore A.

The inner ring 212 has a groove 286 formed along an outer surface 270. The groove 286 faces an inner surface 252 of the outer cylindrical wall 292. The groove 286 has an upper surface 282 and a lower surface 284. The lower surface 284 of the groove 286 is formed at a position substantially even with or coplanar with horizontal top surface 288 of the lip 210 upon fitting the inner ring 212 into the cavity 298. In one embodiment, the material of the inner ring 212 may be selected from a material similar to the material used to fabricate the outer ring 208. Alternatively, the inner ring 212 may be fabricated from a material having similar properties, such as sufficient elastic and frictional force and desired chemical and temperature resistance, but less expensive material for cost reduction concerns. In one embodiment, the materials for fabricating the inner ring 212 may be selected from a group consisting of polyurethane and polyvinyl difloride (PVDF).

In operation, the substrate 104 is positioned on the base 102 disposed on the cleaning system 100, resting on the lip 210 of the drive rollers 106, 108. As the drive rollers 106, 108 and the idlers 110, 112 are moved toward the substrate 104 (as shown by arrow 278), the drive rollers 106, 108 and the idlers 110, 112 contact the edge 504 of the substrate 104. Upon contacting the substrate 104, a reacting and/or counter force generated from the substrate 104 (as shown by arrow 276) may be transmitted to the drive rollers 106, 108 and the idlers 110, 112. Elasticity and flexibility of the material comprising the drive rollers 106, 108 and the idlers 110, 112 allows the contacting surface of rollers 106, 108 and idlers 110, 112 to conform to the substrate for enhanced gripping. As the sloped flange 204 of the outer ring 208 has the tapered portion 252 that guilds the substrate 104 against the lip 250, the sloped flange 204 provides a lateral force to assist the substrate 104 to be more securely gripped within the drive rollers 106, 108. Furthermore, the groove 286 of the inner ring 212 allows the outer wall 292 to flex inwardly, thereby securely contouring to and gripping the substrate 104 (as shown by arrows 274) within the drive roller 106, 108 and preventing the substrate 104 from slipping during rotation.

In one embodiment, the materials utilized to fabricate the idler 110, 112 are selected to have hardness substantial similar to hardness of the material utilized to fabricate the drive roller 106, 108. In one embodiment, the idler 110, 112 and the drive roller 106, 108 are both fabricated from a material selected from a group consisting of polytetrafluoroethylene (PTFE), polytetrafluoroethylene (PTFE) containing material, and fluoroelastomer and polytetrafluoroethylene (PTFE) containing material.

In another embodiment, the material s for fabricating the idler 110, 112 are selected to have hardness higher than the hardness of the materials selected to fabricate the drive rollers 106, 108. As the idler 110, 112 moves to contact the substrate 104, a force may be applied to the substrate 104, providing a pushing pressure toward the substrate 104. The pressure imparted to the substrate 104 is then transmitted from the substrate 104 to the drive rollers 106, 108. The substrate 104 will deform and be gripped by the softer drive rollers 106, 108. In one embodiment, material utilized to fabricate the idlers 110, 112 is selected to have hardness between about 10 Shore A and about 40 Shore A higher than the hardness of the material selected to fabricate the drive roller 106, 108. In another embodiment, the material selected to fabricate the idlers 110, 112 has hardness between about 60 Shore A and about 90 Shore A, such as between about 80 Shore A and about 85 Shore A. Suitable examples of the materials that may be used to fabricate the idlers 110, 112 are selected from a group consisting of polyurethane and polyvinyl difloride (PVDF).

FIGS. 3A-C depict a isometric, a top and a bottom view of one embodiment of the drive roller 106. Referring first to FIG. 3A, as discussed above the drive roller 106, 108 includes the outer ring 208 having the disk-shaped body 220. The disk-shaped body 220 has the center opening 202 formed therethrough. The center opening 202 that allows the shaft 122, 124 to pass therethrough. The center opening 202 allows the drive roller 106, 108 to be mounted to the cleaning system 100 through the shafts 122, 124. The drive roller 106, 108 has at least one sloped flanges 204 formed on the outer surface of disk-shaped body 220 above the lip 210. In the embodiment depicted herein, a plurality of sloped flanges 204 is formed on the outer surface of the drive roller 106, 108.

FIG. 3B depicts a top view of the drive roller 106, 108 as depicted in FIG. 3A which has the center opening 202 formed within the disk-shaped body 220. FIG. 3C depicts a bottom view of the drive roller 106, 108 having the center opening 202 formed through the disk-shaped body 220. The inner ring 212 is capped and inserted within the cavity 298 defined within the outer ring 208.

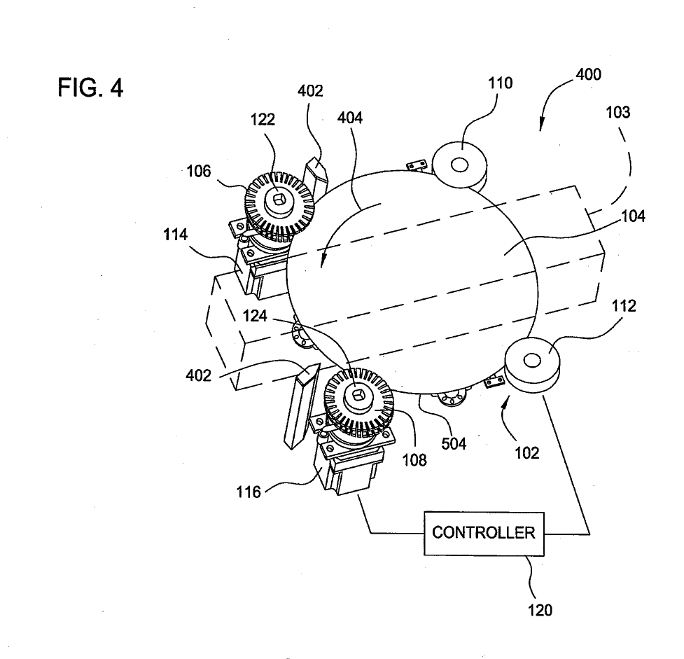

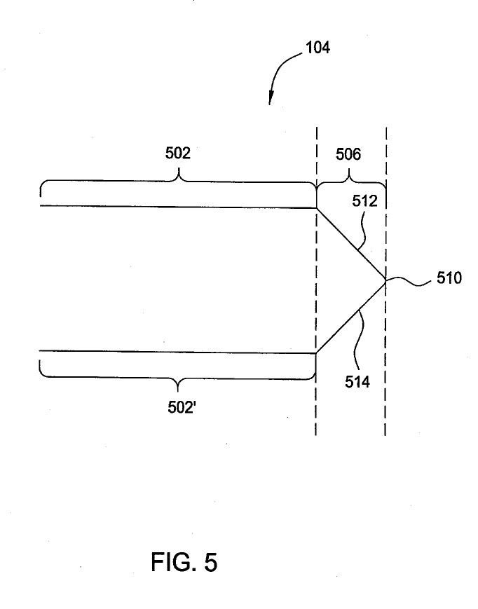

FIG. 4 depicts another embodiment of a cleaning system 400. Similar to the cleaning system 100 of FIG. 1, the cleaning system 400 also includes the base 102, one or more drive rollers 106, 108 and one or more idlers 110, 112. In addition to the mechanical components as depicted in FIG. 1, one or more nozzles 402 may be positioned within the cleaning system 400. In one embodiment, the nozzle 402 may be positioned at a location adjacent to the drive roller 106, 108. The nozzle 402 may direct a fluid spray to the substrate 104. After a number of cleaning cycles, some particles, contaminants, and process residual may be accumulated at the cut-out portion 206 and the sloped flange 204 of the drive roller 106, 108. Accordingly, the nozzle 402 positioned close to the drive rollers 106, 108 may provide a fluid spray to the substrate 104 just prior to contacting the drive rollers 106, 108. In the embodiment wherein the substrate 104 is rotated in a counter clockwise direction (as shown by the arrow 404 in FIG. 4), the nozzle 402 may be positioned at a left side of the drive roller 106, 108, viewing from direction relative to drive roller 106, 108.

In one embodiment, the nozzle 402 may be adjusted to aim fluid supplied from the nozzle 402 at the edge 504 of the substrate 104. The sprayed fluid cleans the substrate edge 504, such as the outer edge 510, and the upper 512 and lower bevel 514 of the substrate 104, as shown in FIG. 5, to wash away the potential contaminant and residuals that may be remained on the substrate 104 prior to contacting the roller. Alternatively, the nozzle 402 may be adjusted and angled in different directions to clean other portions of the substrate 104, including the substrate upper surface 502 or the lower surface 502′.

In one embodiment, the fluid provided from the nozzle 402 may be at least one of nitrogen containing gas, such as N₂, NH₃, N₂O, and inert gas, such as Ar or He. In another embodiment, the fluid provided from the nozzle 402 may be a liquid with moderate chemical properties, such as H₂O, DI water and the like. In the particular embodiment depicted in FIG. 4, the fluid supplied to the cleaning system 400 is N₂ gas. The fluid removes particles from the edge of the substrate 104, thereby reducing roller wear. Additionally, the fluid, particularly when in gaseous form, allows the rollers to more securely grip the substrate, thereby reducing the likelihood of slippage.

Thus, the drive roller with improved material and design provides a good contact surface and rotation control while engaging with a substrate disposed in the cleaning system. The improved material of the drive roller increases the lifetime of the drive roller and lengthens the drive roller replacement cycle time, thereby advantageously reducing the overall manufacture cost. Additionally, the implement of a nozzle close to the drive roller also provide a source of purging a processing gas to an edge and/or bevel of the substrate, thereby promoting the cleaning efficiency of the substrate.

While the foregoing is directed to embodiments of the present invention, other and further embodiments of the invention may be devised without departing from the basic scope thereof, and the scope thereof is determined by the claims that follow.

What is claimed is:

1. A driver roller, comprising:
an outer ring having a disk-shaped body, wherein the disk-shaped body has an inner cylindrical, an upper wall, and an outer cylindrical wall defining a cavity within the disk-shaped body;
an inner ring disposed within the cavity; and
a groove formed along an outer side of the inner ring, the groove facing an inner surface of the outer cylindrical wall of the outer ring.

2. The drive roller of claim 1, further comprising:
a lip extending from an outer surface of the outer cylindrical wall.

3. The drive roller of claim 2, wherein the lip is attached to a bottom of the outer cylindrical wall close to the groove, the lip adapted to receive a substrate positioned thereon.

4. The drive roller of claim 3, wherein the substrate positioned on the lip is engaged toward the groove upon applying a force.

5. The drive roller of claim 1, wherein the outer ring is fabricated by a material selected from a group consisting of polytetrafluoroethylene (PTFE), polytetrafluoroethylene (PTFE) containing material, and fluoroelastomer and polytetrafluoroethylene (PTFE) containing material.

6. The drive roller of claim 3, further comprising:
at least one sloped flange formed on the outer surface of the outer cylindrical wall.

7. The drive roller of claim 6, wherein the sloped flange slopes inward to the lip.

8. The drive roller of claim 6, wherein the sloped flange is arranged to urge the substrate against the lip and into a position above the groove.

9. A cleaning system comprising:
a base;
at least one cleaning element arranged to engage a substrate disposed on the base; and
a drive roller arranged to rotate the substrate disposed on the base; wherein the drive roller is fabricated from a material selected from a group consisting of polytetrafluoroethylene (PTFE), polytetrafluoroethylene (PTFE) containing material and fluoroelastomer and polytetrafluoroethylene (PTFE) containing material, the drive roller having a groove covered by a substrate contact surface, the substrate contact surface configured to deform into the groove when in contact with the rotating substrate.

10. The cleaning system of claim 9, wherein the material of the drive roller has a hardness between about 50 Shore A and about 80 Shore A.

11. The cleaning system of claim 9 further comprising:
at least one idler positioned to engage the substrate against the drive roller.

12. The cleaning system of claim 9, further comprising:
a nozzle disposed adjacent to the drive roller.

13. The cleaning system of claim 12, wherein the nozzle is positioned to direct a fluid to an edge of the substrate.

14. The system of claim 13, wherein the fluid is at least one of air N₂, Ar or He.

15. A cleaning system comprising:
a base adapted to receive a substrate;
at least one cleaning element arranged to interface with the substrate disposed on the base;
at least a drive roller fabricated from a first material adapted to rotate the substrate disposed on the base; and
at least an idler fabricated from a second material adapted to engage the substrate toward the drive roller, wherein the second material has a hardness greater than the first material.

16. The system of claim 15, further comprising:
at least one nozzle disposed adjacent the drive roller and positioned to direct a fluid to an edge of the substrate disposed on the base.

17. The system of claim 16, wherein the fluid is at least one of air, N₂, Ar and He.

18. The system of claim 15, wherein the drive roller further comprises:
an outer ring having an annular body, wherein the annular body has an inner, an upper wall, and an outer wall defining a channel within the annular body;
an inner ring disposed within the channel; and
a groove formed in an outer side of the inner ring and facing an inner surface of the outer wall of the outer ring.

19. The system of claim 18, wherein the outer wall includes a sloped flange and a lip, the outward configured to deform into the groove when in contact with the substrate.

20. The system of claim 15, wherein the first material is polytetrafluoroethylene (PTFE) and the second material is polyurethane.

21. The system of claim 15, wherein hardness of the second material is between about 10 Shore A and about 40 Shore A greater than the first material.
